(19) United States
(12) Patent Application Publication
(10) Pub. No.: US 2026/0161963 A1
(43) Pub. Date: Jun. 11, 2026

(54) MODEL SELECTION METHOD, TERMINAL AND NETWORK-SIDE DEVICE

(71) Applicant: VIVO MOBILE COMMUNICATION CO., LTD., Dongguan (CN)

(72) Inventor: Xiaowen SUN, Dongguan (CN)

(21) Appl. No.: 19/178,781

(22) Filed: Apr. 14, 2025

Related U.S. Application Data
(63) Continuation of application No. PCT/CN2023/124503, filed on Oct. 13, 2023.

(30) Foreign Application Priority Data
Oct. 14, 2022 (CN) 202211261960.4

(51) Int. Cl. G06N 5/022

(52) U.S. Cl. CPC G06N 5/022

(57) ABSTRACT

Provided are a model selection method, a terminal, and a network side device. The model selection method includes following operations. A terminal sends first computing information, where the first computing information is related to a computing capability of the terminal, and the first computing information is used for determining a first AI model used by the terminal. The terminal receives parameter(s) of the first AI model, where the first AI model is used by the terminal to perform a target task.

### CROSS-REFERENCE TO RELATED APPLICATIONS

This application is a continuation of International Patent Application No. PCT/CN2023/124503, filed on Oct. 13, 2023, which claims priority to Chinese Patent Application No. 202211261960.4 filed on Oct. 14, 2022, both of which are incorporated herein by reference in their entireties.

### TECHNICAL FIELD

This application belongs to the field of communication technologies, and specifically, to a model selection method, a terminal, and a network side device.

### BACKGROUND

When a complex task (for example, image recognition) like image processing is performed, some inference parts usually need to be offloaded from a terminal side to a network side (for example, an edge data center or a cloud data center). Consequently, an artificial intelligence (Artificial Intelligence, AI) model used for image processing is distributed between a plurality of endpoints (for example, the terminal and a network side device).

### SUMMARY

Embodiments of this application provide a model selection method, a terminal, and a network side device.

According to a first aspect, a model selection method is provided, including:
sending, by a terminal, first computing information, where the first computing information is related to a computing capability of the terminal, and the first computing information is used for determining a first AI model used by the terminal; and receiving, by the terminal, parameter(s) of the first AI model, where the first AI model is used by the terminal to perform a target task.

According to a second aspect, a model selection method is provided, including: determining, by a network side device based on first computing information of a terminal, a first AI model used by the terminal, where the first computing information is related to a computing capability of the terminal; and sending, by the network side device, parameter(s) of the first AI model, where the first AI model is used by the terminal to perform a target task.

According to a third aspect, a model selection apparatus is provided, including: a capability delivery module, configured to send first computing information, where the first computing information is related to a computing capability of the apparatus, and the first computing information is used for determining a first AI model used by the apparatus; and a receiving module, configured to receive parameter(s) of the first AI model, where the first AI model is used by the apparatus to perform a target task.

According to a fourth aspect, a model selection apparatus is provided, including: a model selection module, configured to determine, based on first computing information of a terminal, a first AI model used by the terminal, where the first computing information is related to a computing capability of the terminal; and a sending module, configured to send parameter(s) of the first AI model, where the first AI model is used by the terminal to perform a target task.

According to a fifth aspect, a terminal is provided. The terminal includes a processor and a memory. The memory stores a program or instructions executable on the processor. The program or the instructions, when executed by the processor, implement the steps of the method according to the first aspect.

According to a sixth aspect, a terminal is provided, including a processor and a communication interface. The communication interface is configured to: send first computing information, where the first computing information is related to a computing capability of the terminal, and the first computing information is used for determining a first AI model used by the terminal; and receive parameter(s) of the first AI model, where the first AI model is used by the terminal to perform a target task.

According to a seventh aspect, a network side device is provided. The network side device includes a processor and a memory. The memory stores a program or instructions executable on the processor. The program or the instructions, when executed by the processor, implement the steps of the method according to the second aspect.

According to an eighth aspect, a network side device is provided, including a processor and a communication interface. The processor is configured to determine, based on first computing information of a terminal, a first AI model used by the terminal, where the first computing information is related to a computing capability of the terminal; and the communication interface is configured to send parameter(s) of the first AI model, where the first AI model is used by the terminal to perform a target task.

According to a ninth aspect, a model selection system is provided, including a terminal and a network side device, where the terminal may be configured to implement the steps of the method according to the first aspect, and the network side device may be configured to implement the steps of the method according to the second aspect.

According to a tenth aspect, a readable storage medium is provided. The readable storage medium stores a program or instructions. The program or the instructions, when executed by a processor, implement the steps of the method according to the first aspect or the steps of the method according to the second aspect.

According to an eleventh aspect, a chip is provided. The chip includes a processor and a communication interface. The communication interface is coupled to the processor, and the processor is configured to execute the program or the instructions, to implement the steps of the method according to the first aspect or the steps of the method according to the second aspect.

According to a twelfth aspect, a computer program/program product is provided. The computer program/program product is stored in a storage medium. The computer program/program product is executed by at least one processor, to implement the steps of the method according to the first aspect or the steps of the method according to the second aspect.

### BRIEF DESCRIPTION OF THE DRAWINGS

FIG. 1 is a schematic diagram of a wireless communication system according to an embodiment of this application;

FIG. 2 is a schematic flowchart of a model selection method according to an embodiment of this application;

FIG. 3 is a schematic diagram of a system architecture of a model selection method according to an embodiment of this application;

FIG. 4 is a schematic diagram of a system architecture of a model selection method according to an embodiment of this application;

FIG. 5 is a schematic diagram of a system architecture of a model selection method according to an embodiment of this application;

FIG. 6 is a schematic flowchart of a model selection method according to an embodiment of this application;

FIG. 7 is a schematic structural diagram of a model selection apparatus according to an embodiment of this application;

FIG. 8 is a schematic structural diagram of a model selection apparatus according to an embodiment of this application;

FIG. 9 is a schematic structural diagram of a communication device according to an embodiment of this application;

FIG. 10 is a schematic structural diagram of a terminal according to an embodiment of this application; and

FIG. 11 is a schematic structural diagram of a network side device according to an embodiment of this application.

### DETAILED DESCRIPTION

The technical solutions in embodiments of this application are clearly described below with reference to the accompanying drawings in embodiments of this application. Apparently, the described embodiments are some rather than all of embodiments of this application. All other embodiments obtained by a person of ordinary skill in the art based on embodiments of this application fall within the protection scope of this application.

Terms “first”, “second”, and the like in this specification and the claims of this application are used to distinguish between similar objects instead of describing a specific order or sequence. It should be understood that the terms used in this way are interchangeable in a proper case, so that embodiments of this application can be implemented in other orders than the orders illustrated or described herein. Moreover, the objects distinguished by “first” and “second” are usually of one type, and the quantity of objects is not limited. For example, there may be one or more first objects. In addition, “and/or” in this specification and the claims represents at least one of connected objects, and the character “/” generally indicates an “or” relationship between associated objects.

It should be noted that technologies described in embodiments of this application are not limited to a long term evolution (Long Term Evolution, LTE)/LTE-advanced (LTE-Advanced, LTE-A) system, and may be further applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single carrier frequency division multiple access (Single Carrier Frequency Division Multiple Access, SC-FDMA), and other systems. In embodiments of this application, terms “system” and “network” are usually used interchangeably, and the technologies described can be applied to the systems and radio technologies mentioned above, and can also be applied to other systems and radio technologies. A new radio (New Radio, NR) system is described below as an example, and the term NR is used in most of the following descriptions. Nevertheless, the technologies may also be applied to applications other than applications of the NR system, like a 6th generation (6th Generation, 6G) communication system.

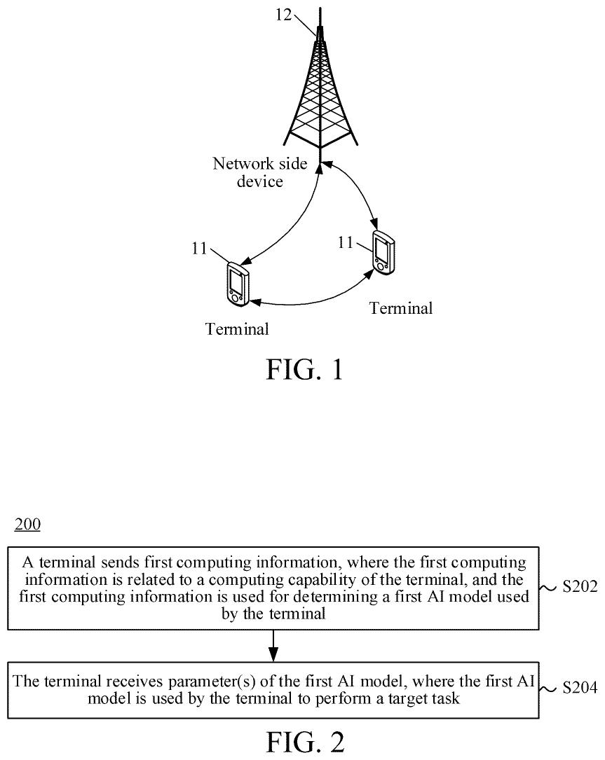

FIG. 1 is a block diagram of a wireless communication system to which an embodiment of this application can be applied. The wireless communication system includes terminals 11 and a network side device 12. The terminal 11 may be a terminal side device like a mobile phone, a tablet personal computer (Tablet Personal Computer), a laptop computer (Laptop Computer) or referred to as a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle user equipment (VUE), pedestrian user equipment (PUE), smart home (home equipment with wireless communication functions, like a refrigerator, a television, a washing machine, or furniture), a game console, a personal computer (personal computer, PC), a teller machine, or a self-service machine. The wearable device includes: a smart watch, a smart band, smart headphones, smart glasses, smart jewelry (a smart bangle, a smart bracelet, a smart ring, a smart necklace, a smart anklet, a smart ankle chain, and the like), a smart wristband, smart clothing, and the like. It should be noted that in embodiments of this application, a specific type of the terminal 11 is not limited. The network side device 12 may include an access network device, a core network device, a server, or the like. The server may include a network-side edge computing server, a cloud server, or the like. The access network device may also be referred to as a radio access network device, a radio access network (Radio Access Network, RAN), a radio access network function, or a radio access network unit. The access network device may include a base station, a WLAN access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another proper term in the field. Provided that the same technical effect is achieved, the base station is not limited to a specific technical vocabulary. It should be noted that, in embodiments of this application, only a base station in an NR system is used as an example for description, and a specific type of the base station is not limited.

A model selection method according to embodiments of this application is described in detail below through some embodiments and application scenarios thereof with reference to the accompanying drawings.

When image recognition or another media task is performed, due to limited capabilities of a terminal, interaction between the terminal side and a network side may be involved. An AI model for AI processing is selected or split, and some AI processing tasks are handed over to an edge computing server or a centralized server on the network side for processing.

During AI model selection or split, to further adapt a processing capability of the terminal, an embodiment of this application provides a model selection or split processing method based on computing information, which is specifically as follows: A terminal side has a computing collection function, and is responsible for collecting first computing information related to computing task processing by the terminal and transferring the first computing information to a network side through a 5GS. The network side selects a first AI model corresponding to the terminal based on the first computing information of the terminal and the like. In a scenario of model split, the network side determines a model split point based on the first computing information of the terminal and second computing information (for example, computing of a network-side edge computing server or a cloud server) of a network side device, to select the first AI model corresponding to the terminal side, and the like.

As shown in FIG. 2, an embodiment of this application provides a model selection method 200. The method may be performed by a terminal. In other words, the method may be performed by software or hardware installed in the terminal. The method includes the following steps.

S202: The terminal sends first computing information, where the first computing information is related to a computing capability of the terminal, and the first computing information is used for determining a first AI model used by the terminal.

In this embodiment, the computing capability of the terminal may be: a capability of the terminal to process an AI model in a task like image processing. Optionally, before S202, the terminal may further collect the first computing information.

The first computing information described in embodiments of this application may be related to at least one of the following of the terminal: a memory size (for example, a remaining memory size or a total memory size), a capability of a central processing unit (CPU), a hard disk data size, computing, and a (current) load size. The computing includes, for example, floating-point operations per second (Flops).

Optionally, the first AI model is selected by the network side device for the terminal based on the first computing information, and the first computing information matches the first AI model. For example, the selected first AI model satisfies that computing required when the first AI model is used is in positive correlation with the computing capability of the terminal side. To be specific, a stronger computing capability of the terminal side indicates stronger computing required when the selected first AI model is used. Otherwise, a weaker computing capability of the terminal side indicates weaker computing required when the selected first AI model is used.

This embodiment is conducive to selecting, for the terminal, the first AI model matching the first computing information of the terminal. The terminal can perform the target task by using a suitable AI model. This helps improve quality of a processing result obtained by the terminal.

Optionally, the first AI model is obtained by splitting a second AI model based on the first computing information and/or second computing information of a network side device.

For example, the network side device splits the second AI model into the first AI model and a third AI model based on parameters such as a quantity of model layers of the second AI model and a task amount or complexity of a processing task of each model layer and with reference to the first computing information and/or the second computing information. The first AI model is an AI model used on the terminal side, and the second AI model is an AI model used on a network side (for example, an edge data center or a cloud data center).

S204: The terminal receives parameter(s) of the first AI model, where the first AI model is used by the terminal to perform a target task.

In this embodiment, the terminal may receive the parameter(s) of the first AI model from the network side device, and the parameter(s) of the first AI model may constitute the first AI model. The first AI model is used by the terminal to perform the target task, for example, used by the terminal to perform an image recognition task.

According to the model selection method provided in this embodiment of this application, the terminal sends the first computing information, where the first computing information is related to the computing capability of the terminal, and the first computing information is used for determining the first AI model used by the terminal. The terminal receives the parameter(s) of the first AI model, and then obtains the first AI model based on the parameter(s) of the first AI model. This embodiment is conducive to selecting, for the terminal, the first AI model matching the first computing information of the terminal. The terminal can perform the target task by using a suitable AI model. This helps improve quality of an obtained processing result.

Optionally, in an embodiment, after the terminal receives the parameter(s) of the first AI model, the method further includes: The terminal obtains first data, where the first data is related to the target task; and the terminal processes the first data based on the first AI model.

In this embodiment, for example, the first AI model is used for a face recognition task. The terminal locally acquires face image data. The terminal processes the face image data based on the first AI model to obtain a face recognition result.

Optionally, in an embodiment, after the terminal receives the parameter(s) of the first AI model, the method further includes: The terminal receives second data, where the second data is related to the target task, the second data is a result obtained through processing based on a third AI model, and the third AI model is obtained by splitting the second AI model based on the first computing information and/or the second computing information of the network side device. The terminal processes the second data based on the first AI model.

In this embodiment, for example, the first AI model and the second AI model are used for an image recognition task. The network side locally acquires image data. The network side processes the image data based on the second AI model to obtain intermediate result data of the image recognition, namely, the second data. The network side sends the intermediate result data to the terminal. The terminal processes the intermediate result data based on the first AI model to obtain final result data of the image recognition.

Optionally, in an embodiment, after the terminal receives the parameter(s) of the first AI model, the method further includes: The terminal obtains third data, where the third data is related to the target task. The terminal processes the third data based on the first AI model, to obtain fourth data. The terminal sends the fourth data. The terminal receives fifth data, where the fifth data is a result obtained through processing based on a third AI model, and the third AI model is obtained by splitting the second AI model based on the first computing information and/or the second computing information of the network side device.

In this embodiment, for example, the first AI model and the second AI model are used for an image recognition task. The terminal locally acquires image data, namely, the third data. The terminal processes the image data based on the first AI model to obtain intermediate result data of the image recognition, namely, the fourth data. The terminal sends the intermediate result data to the network side. The network side processes the intermediate result data based on the second AI model to obtain final result data of the image recognition, namely, the fifth data. Finally, the network side device sends the final result data of the image recognition to the terminal.

To describe the model selection method provided in embodiments of this application in detail, the following describes the method with reference to several specific embodiments.

### Embodiment 1

This embodiment mainly describes a basic model distribution process based on computing information. In this embodiment, modules included in the terminal side and the network side are shown in FIG. 3.

### Network Side

An AI model capability collection (AI Model Capability Collection) function is responsible for collecting a capability (namely, first computing information) of the terminal performing AI processing, for example, a memory, a CPU, hard disk data, and computing of the terminal such as Flops and a current load condition.

An AI model selection (AI Model Selection) function selects a suitable AI model based on related information of a processing AI server (for example, processing task attributes like image rendering or image recognition) and a terminal capability (including computing information of the terminal) collected by the AI model capability collection function.

The AI model capability collection function and the AI model selection function are logical functions, and may exist alone, or may be separately or both co-deployed with another function, for example, co-deployed with a network application (Network Application) or an AI model repository (AI Model Repository).

The network application may select, from the AI model repository, a specific type of AI model like an image recognition model or a model for processing another task for an AI media service or the like. The AI model selection function may further select a model for the terminal based on a capability of the terminal from models selected by the network application.

An AI model delivery function (AI Model Delivery Function) sends AI model data to the terminal through a 5GS (5G system). The AI model delivery function may further include functions related to a quality of service (Quality of Service, QoS) request and monitoring, and functions related to optimization or compression of the AI model data.

### Terminal Side

A terminal application (UE Application) provides an AI media service by using an AI model inference engine (AI Model Inference engine) and an AI model access function (AI Model Access Function, or referred to as an AI model access function).

The AI model access function receives AI model data through a 5G system and sends the AI model data to the AI model inference engine, which may include a receiving-end optimization or decompression technology used for the AI model data.

The AI model inference engine performs inference by using input data from a data source (Data Source, for example, a camera or another media source) as input of an AI model. Inference output data is sent to a data destination (Data Destination, for example, a media player).

A terminal capability delivery function (UE Capability Delivery Function) is responsible for collecting a terminal capability, for example, a memory, a CPU, hard disk data, and computing of the terminal such as Flops and a current load condition, and transmits the terminal capability to the network through a 5GS, so that the network performs model selection based on computing information, and subsequently performs model split processing based on different computing of the terminal and the network in a split (Split) scenario.

### Embodiment 2

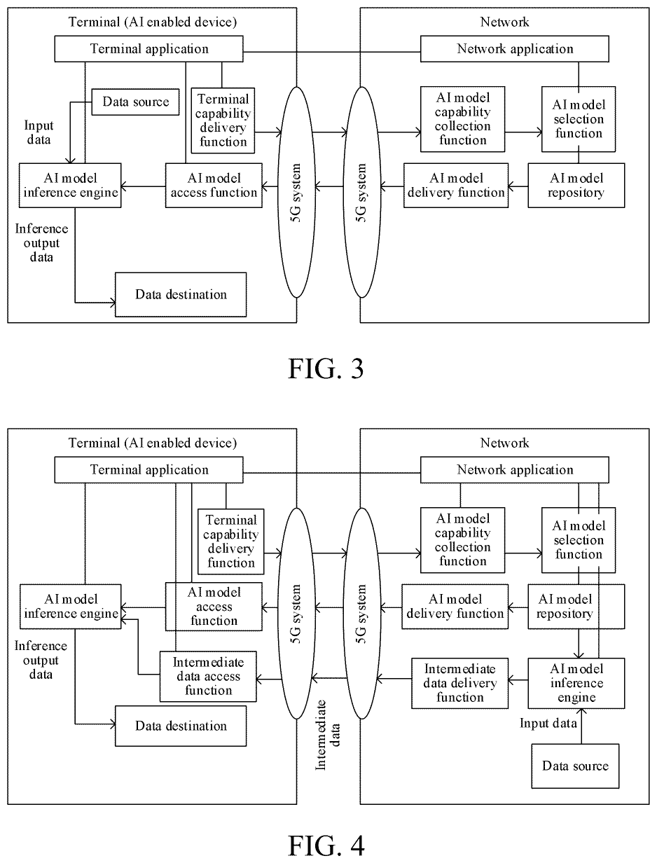

This embodiment mainly describes a distributed inference procedure of collaboration between the terminal and the network, where a data source is in the network. In this embodiment, modules included in the terminal side and the network side are shown in FIG. 4.

### Network Side

An AI model capability collection (AI Model Capability Collection) function is responsible for collecting a capability (namely, first computing information) of the terminal performing AI processing, for example, a memory, a CPU, hard disk data, and computing of the terminal such as Flops and a current load condition.

In a split scenario, the AI model capability collection function also obtains a related processing capability of the network side through a network application or in another manner, for example, a memory, a CPU, hard disk data, and computing of a processing server such as Flops and a current load condition (for example, a processing capability of an edge computing server or a central cloud server may be obtained).

An AI model selection (AI Model Selection) function selects a suitable AI model based on related information of a processing AI server (for example, processing task attributes like image rendering or image recognition) and a terminal capability (including computing information of the terminal) collected by the AI model capability collection function.

In a split scenario, the AI model selection function needs to determine a model split solution based on a terminal processing capability and a network server processing capability that are collected, and determine an AI model for processing by the terminal and the network, that is, determine split points (Split Points).

The AI model capability collection function and the AI model selection function are logical functions, and may exist alone, or may be separately or both co-deployed with another function, for example, co-deployed with a network application (Network Application) or an AI model repository (AI Model Repository).

An AI model inference engine (AI Model Inference Engine) receives a network artificial intelligence model subset (including an AI model executed by the terminal and an AI model executed by the network) and input data of a data source (Data Source, for example, a media repository) for network inference.

An intermediate data delivery function (Intermediate Data Delivery Function) receives partial inference output (intermediate data) from the AI model inference engine, and sends the partial inference output to the terminal through a 5GS. The intermediate data delivery function may further include functions related to a QoS request and monitoring.

In this embodiment, for functions of modules such as the AI model repository and an AI model delivery function, refer to the descriptions in FIG. 3.

### Terminal Side

An intermediate data access function (Intermediate Data Access Function) receives intermediate data from the network through a 5GS, and sends the intermediate data to an AI model inference engine (AI Model Inference Engine) of the terminal for terminal inference. Finally, inference output data is sent to a data destination (for example, a media player).

A terminal capability delivery function (UE Capability Delivery Function) is responsible for collecting a terminal capability, for example, a memory, a CPU, hard disk data, and computing of the terminal such as Flops and a current load condition, and transmits the terminal capability to the network through the 5GS, so that the network performs model selection based on computing information, and subsequently performs model split processing based on different computing of the terminal and the network in a split (Split) scenario.

In this embodiment, for functions of a module like an AI model access function, refer to the descriptions in FIG. 3.

### Embodiment 3

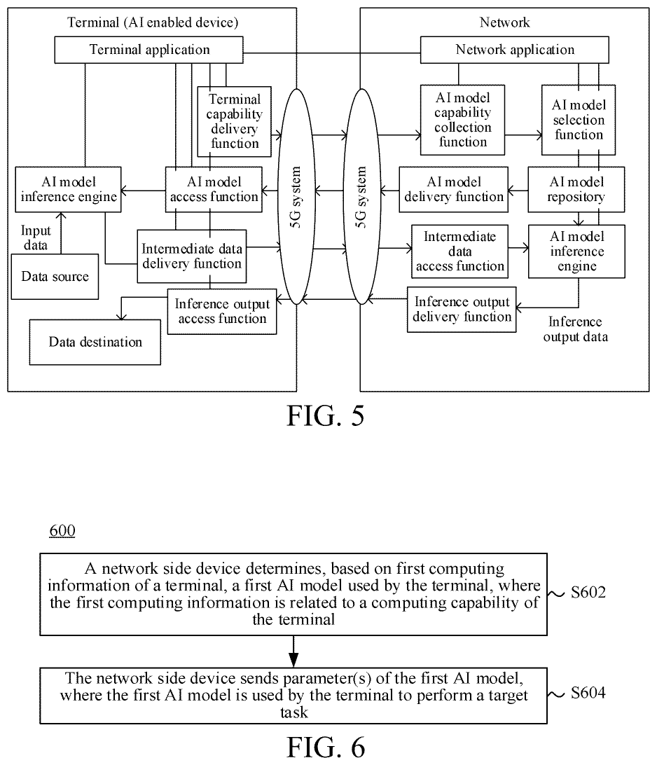

This embodiment mainly describes a distributed inference procedure of collaboration between the terminal and the network, where a data source is in the terminal. In this embodiment, modules included in the terminal side and the network side are shown in FIG. 5.

### Network Side

An AI model capability collection (AI Model Capability Collection) function is responsible for collecting a capability (namely, first computing information) of the terminal performing AI processing, for example, a memory, a CPU, hard disk data, and computing of the terminal such as Flops and a current load condition.

In a split scenario, the AI model capability collection function also obtains a related processing capability of the network side through a network application or in another manner, for example, a memory, a CPU, hard disk data, and computing of a processing server such as Flops and a current load condition (for example, a processing capability of an edge computing server or a central cloud server may be obtained).

An AI model selection (AI Model Selection) function selects a suitable AI model based on related information of a processing AI server (for example, processing task attributes like image rendering or image recognition) and a terminal capability (including computing information of the terminal) collected by the AI model capability collection function.

In a split scenario, the AI model selection function needs to determine a model split solution based on a terminal processing capability and a network server processing capability that are collected, and determine an AI model for processing by the terminal and the network, that is, determine split points (Split Points).

The AI model capability collection function and the AI model selection function are logical functions, and may exist alone, or may be separately or both co-deployed with another function, for example, co-deployed with a network application (Network Application) or an AI model repository (AI Model Repository).

An intermediate data access function (Intermediate Data Access Function) receives intermediate data from the terminal through a 5GS, and sends the intermediate data to an AI model inference engine for network inference.

Finally, inference output data of the AI model inference engine is sent to the terminal by using an inference output delivery function (Inference Output Delivery Function) through the 5GS.

In this embodiment, for functions of modules such as the AI model repository and an AI model delivery function, refer to the descriptions in FIG. 3.

### Terminal Side

An AI model inference engine (AI Model Inference Engine) receives a network AI model subset and input data (from a UE data source), for UE inference.

An intermediate data delivery function (Intermediate Data Delivery Function) receives partial inference output (intermediate data) from the AI model inference engine, and sends the partial inference output to the network through a 5GS. The intermediate data delivery function may further include functions related to a QoS request and monitoring.

An inference output access function (Inference Output Access Function) receives inference output data from the network through the 5GS, and sends the inference output data to a related data destination based on an AI media service.

In this embodiment, for functions of modules such as an AI model access function and a terminal capability delivery function, refer to the descriptions in FIG. 3.

It should be noted that embodiments of this application are not only applicable to a 5G Media system, but also applicable to another scenario like split rendering.

The model selection method according to embodiments of this application is described in detail above with reference to FIG. 2 to FIG. 5. A model selection method according to another embodiment of this application is described in detail below with reference to FIG. 6. It may be understood that interaction between a network side device and a terminal described on the network side device is the same as or corresponds to that described on the terminal side in the method shown in FIG. 2. To avoid repetition, relevant descriptions are properly omitted.

FIG. 6 is a schematic flowchart of implementation of a model selection method according to an embodiment of this application. The method may be applied to a network side device. As shown in FIG. 6, the method 600 includes the following steps.

S602: The network side device determines, based on first computing information of a terminal, a first AI model used by the terminal, where the first computing information is related to a computing capability of the terminal.

S604: The network side device sends parameter(s) of the first AI model, where the first AI model is used by the terminal to perform a target task.

According to the model selection method provided in this embodiment of this application, the network side device determines, based on the first computing information of the terminal, the first AI model used by the terminal, where the first computing information is related to the computing capability of the terminal. This embodiment is conducive to selecting, for the terminal, the first AI model matching the first computing information of the terminal. The terminal can perform the target task by using a suitable AI model. This helps improve quality of an obtained processing result.

Optionally, in an embodiment, the method further includes at least one of the following: (1) the network side device obtains the first computing information; or (2) the network side device obtains second computing information of the network side device.

Optionally, in an embodiment, that the network side device determines, based on the first computing information of the terminal, the first AI model used by the terminal includes: The network side device splits a second AI model based on the first computing information of the terminal and the second computing information of the network side device, to obtain the first AI model used by the terminal and a third AI model used by the network side device.

Optionally, in an embodiment, the first computing information is related to at least one of the following of the terminal: a memory size, a capability of a central processing unit, a hard disk data size, computing, or a load size; and the second computing information is related to at least one of the following of the network side device: a memory size, a capability of a central processing unit, a hard disk data size, computing, or a load size.

Optionally, in an embodiment, after the network side device sends the parameter(s) of the first AI model, the method further includes: The network side device sends second data, where the second data is related to the target task, and the second data is a result obtained through processing based on the third AI model.

Optionally, in an embodiment, after the network side device sends the parameter(s) of the first AI model, the method further includes: The network side device receives fourth data, where the fourth data is obtained by the terminal by processing third data based on the first AI model; the network side device processes the fourth data based on the third AI model, to obtain fifth data; and the network side device sends the fifth data.

The model selection method provided in this embodiment of this application may be performed by a model selection apparatus. In this embodiment of this application, the model selection apparatus provided in this embodiment of this application is described with an example in which the model selection apparatus performs the model selection method.

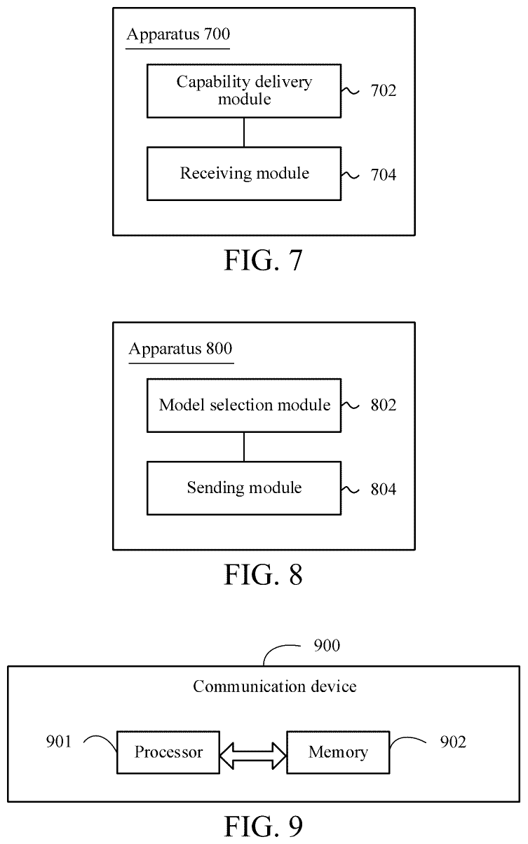

FIG. 7 is a schematic structural diagram of a model selection apparatus according to an embodiment of this application. The apparatus may correspond to a terminal in other embodiments. As shown in FIG. 7, the apparatus 700 includes the following modules:
a capability delivery module 702, configured to send first computing information, where the first computing information is related to a computing capability of the apparatus, and the first computing information is used for determining a first AI model used by the apparatus; and
a receiving module 704, configured to receive parameter(s) of the first AI model, where the first AI model is used by the apparatus to perform a target task.

The model selection apparatus provided in this embodiment of this application sends the first computing information, where the first computing information is related to the computing capability of the apparatus, and the first computing information is used for determining the first AI model used by the apparatus. The apparatus sends the parameter(s) of the first AI model. This embodiment is conducive to selecting, for the apparatus, the first AI model matching the first computing information of the apparatus. The apparatus can perform the target task by using a suitable AI model. This helps improve quality of an obtained processing result.

Optionally, in an embodiment, the first AI model is obtained by splitting a second AI model based on the first computing information and/or second computing information of a network side device.

Optionally, in an embodiment, the first computing information is related to at least one of the following of the apparatus: a memory size, a capability of a central processing unit, a hard disk data size, computing, or a load size.

Optionally, in an embodiment, the apparatus further includes: an obtaining module, configured to obtain first data, where the first data is related to the target task; and a processing module, configured to process the first data based on the first AI model.

Optionally, in an embodiment, the receiving module 704 is further configured to receive second data, where the second data is related to the target task, the second data is a result obtained through processing based on a third AI model, and the third AI model is obtained by splitting the second AI model based on the first computing information and/or the second computing information of the network side device; and the apparatus further includes a processing module, configured to process the second data based on the first AI model.

Optionally, in an embodiment, the apparatus further includes an obtaining module, configured to obtain third data, where the third data is related to the target task; the apparatus further includes a processing module, configured to process the third data based on the first AI model, to obtain fourth data; the apparatus further includes a sending module, configured to send the fourth data; and the receiving module 704 is further configured to receive fifth data, where the fifth data is a result obtained through processing based on a third AI model, and the third AI model is obtained by splitting the second AI model based on the first computing information and/or the second computing information of the network side device.

For the apparatus 700 according to this embodiment of this application, refer to the procedure of the method 200 corresponding to embodiments of this application. In addition, each unit/module in the apparatus 700 and the foregoing other operations and/or functions are respectively used to implement corresponding procedures in the method 200 and can achieve the same or equivalent technical effects. For brevity, details are not described herein again.

The model selection apparatus in this embodiment of this application may be an electronic device, for example, an electronic device having an operating system, or a component in an electronic device, like an integrated circuit or a chip. The electronic device may be a terminal or another device than a terminal. For example, the terminal may include, but is not limited to, the types of the terminal 11 listed above, and the another device may be a server, a network attached storage (Network Attached Storage, NAS), or the like. This is not specifically limited in embodiments of this application.

FIG. 8 is a schematic structural diagram of a model selection apparatus according to an embodiment of this application. The apparatus may correspond to a network side device in other embodiments. As shown in FIG. 8, the apparatus 800 includes the following modules:
a model selection module 802, configured to determine, based on first computing information of a terminal, a first AI model used by the terminal, where the first computing information is related to a computing capability of the terminal; and
a sending module 804, configured to send parameter(s) of the first AI model, where the first AI model is used by the terminal to perform a target task.

The model selection apparatus provided in this embodiment of this application determines, based on the first computing information of the terminal, the first AI model used by the terminal, where the first computing information is related to the computing capability of the terminal. This embodiment is conducive to selecting, for the terminal, the first AI model matching the first computing information of the terminal. The terminal can perform the target task by using a suitable AI model. This helps improve quality of an obtained processing result.

Optionally, in an embodiment, the apparatus further includes an obtaining module, configured to perform at least one of the following: obtain the first computing information; or obtain second computing information of the apparatus.

Optionally, in an embodiment, the model selection module 802 is configured to split a second AI model based on the first computing information of the terminal and the second computing information of the apparatus, to obtain the first AI model used by the terminal and a third AI model used by the apparatus.

Optionally, in an embodiment, the first computing information is related to at least one of the following of the terminal: a memory size, a capability of a central processing unit, a hard disk data size, computing, or a load size; and the second computing information is related to at least one of the following of the apparatus: a memory size, a capability of a central processing unit, a hard disk data size, computing, or a load size.

Optionally, in an embodiment, the sending module 804 is further configured to send second data, where the second data is related to the target task, and the second data is a result obtained through processing based on the third AI model.

Optionally, in an embodiment, the apparatus further includes a receiving module, configured to receive fourth data, where the fourth data is obtained by the terminal by processing third data based on the first AI model; the apparatus further includes a processing module, configured to process the fourth data based on the third AI model, to obtain fifth data; and the sending module 804 is further configured to send the fifth data.

For the apparatus 800 according to this embodiment of this application, refer to the procedure of the method 600 corresponding to embodiments of this application. In addition, each unit/module in the apparatus 800 and the foregoing other operations and/or functions are respectively used to implement corresponding procedures in the method 600 and can achieve the same or equivalent technical effects. For brevity, details are not described herein again.

The model selection apparatus provided in this embodiment of this application can implement the processes implemented in the method embodiments of FIG. 2 to FIG. 6, and achieve the same technical effects. To avoid repetition, details are not described herein again.

Optionally, as shown in FIG. 9, an embodiment of this application further provides a communication device 900, including a processor 901 and a memory 902. The memory 902 stores a program or instructions executable on the processor 901. For example, when the communication device 900 is a terminal, the foregoing steps in embodiments of the model selection method are implemented when the program or the instructions are executed by the processor 901, and the same technical effects can be achieved. When the communication device 900 is a network side device, the foregoing steps in embodiments of the model selection method are implemented when the program or the instructions are executed by the processor 901, and the same technical effects can be achieved. To avoid repetition, details are not described herein again.

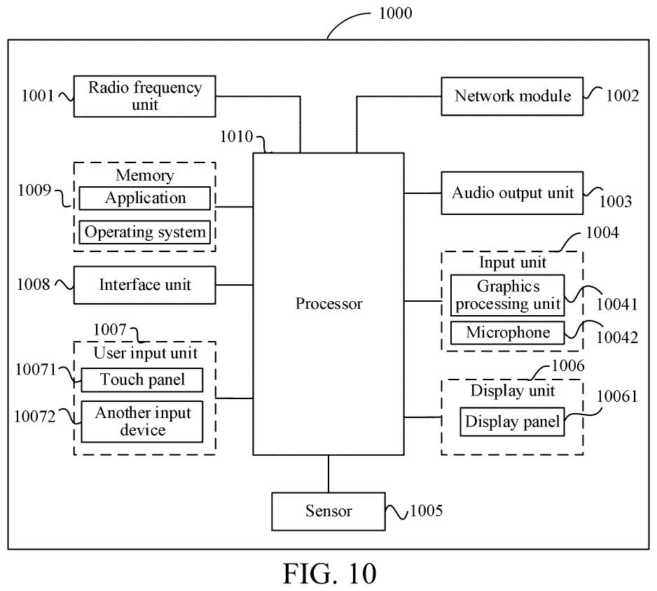

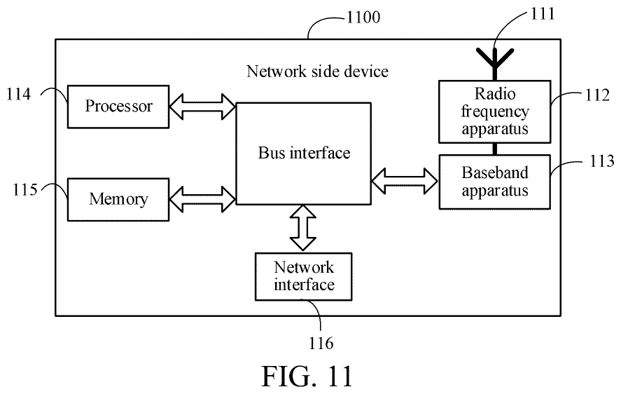

An embodiment of this application further provides a terminal, including a processor and a communication interface. The communication interface is configured to: send first computing information, where the first computing information is related to a computing capability of the terminal, and the first computing information is used for determining a first AI model used by the terminal; and receive parameter(s) of the first AI model, where the first AI model is used by the terminal to perform a target task. This terminal embodiment corresponds to the foregoing terminal-side method embodiment, and each implementation process and implementation of the foregoing method embodiment can be applied to the terminal embodiment, and can achieve the same technical effects. Specifically, FIG. 10 is a schematic diagram of a hardware structure of a terminal for implementing an embodiment of this application.

The terminal 1000 includes, but is not limited to, at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (for example, a battery) that supplies power to each component. The power supply may be logically connected to the processor 1010 through a power supply management system, to implement functions such as charging and discharging management, and power consumption management through the power supply management system. The terminal structure shown in FIG. 10 constitutes no limitation on the terminal, and the terminal may include more or fewer components than those shown in the figure, or combine some components, or have different component arrangements. Details are not described herein again.

It should be understood that in this embodiment of this application, the input unit 1004 may include a graphics processing unit (Graphics Processing Unit, GPU) 10041 and a microphone 10042. The graphics processing unit 10041 processes image data of a static picture or video obtained by an image capturing apparatus (for example, a camera) in a video capturing mode or an image capturing mode. The display unit 1006 may include a display panel 10061. The display panel 10061 may be configured in the form of a liquid crystal display, an organic light emitting diode, or the like. The user input unit 1007 includes at least one of a touch panel 10071 and another input device 10072. The touch panel 10071 is also known as a touchscreen. The touch panel 10071 may include two parts: a touch detection apparatus and a touch controller. The another input device 10072 may include, but is not limited to, a physical keyboard, a functional key (for example, a volume control key or a switch key), a track ball, a mouse, and a joystick. Details are not described herein again.

In this embodiment of this application, the radio frequency unit 1001 receives downlink data from a network side device and then transmits the data to the processor 1010 for processing. In addition, the radio frequency unit 1001 may send uplink data to the network side device. Generally, the radio frequency unit 1001 includes, but is not limited to, an antenna, an amplifier, a transceiver, a coupler, a low noise amplifier, a duplexer, and the like.

The memory 1009 may be configured to store a software program or instructions and various data. The memory 1009 may mainly include a first storage area for storing a program or instructions and a second storage area for storing data. The first storage area may store an operating system, an application or instructions required for at least one function (for example, a sound playing function or an image playing function), and the like. In addition, the memory 1009 may include a volatile memory or a non-volatile memory, or the memory 1009 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (static RAM, SRAM), a dynamic random access memory (dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), or a direct rambus random access memory (Direct Rambus RAM, DR RAM). The memory 1009 in this embodiment of this application includes, but is not limited to, these memories and any other memory of a suitable type.

The processor 1010 may include one or more processing units. Optionally, the processor 1010 integrates an application processor and a modem processor. The application processor mainly processes operations related to an operating system, a user interface, an application, and the like. The modem processor mainly processes wireless communication signals, and is, for example, a baseband processor. It may be understood that the foregoing modem processor may alternatively not be integrated into the processor 1010.

The radio frequency unit 1001 may be configured to: send first computing information, where the first computing information is related to a computing capability of the terminal, and the first computing information is used for determining a first AI model used by the terminal; and receive parameter(s) of the first AI model, where the first AI model is used by the terminal to perform a target task.

In this embodiment of this application, the terminal sends the first computing information, where the first computing information is related to the computing capability of the terminal, and the first computing information is used for determining the first AI model used by the terminal. The terminal receives the parameter(s) of the first AI model. This embodiment is conducive to selecting, for the terminal, the first AI model matching the first computing information of the terminal. The terminal can perform the target task by using a suitable AI model. This helps improve quality of an obtained processing result.

The terminal 1000 provided in this embodiment of this application can further implement the foregoing processes in embodiments of the model selection method, and can achieve the same technical effects. To avoid repetition, details are not described herein again.

An embodiment of this application further provides a network side device, including a processor and a communication interface. The processor is configured to determine, based on first computing information of a terminal, a first AI model used by the terminal, where the first computing information is related to a computing capability of the terminal; and the communication interface is configured to send parameter(s) of the first AI model, where the first AI model is used by the terminal to perform a target task. This network side device embodiment corresponds to the foregoing network side device method embodiment. Each implementation process and implementation of the foregoing method embodiment can be applied to this network side device embodiment, and can achieve the same technical effects.

Specifically, an embodiment of this application further provides a network side device. As shown in FIG. 11, the network side device 1100 includes: an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends the processed information to the radio frequency apparatus 112. The radio frequency apparatus 112 processes the received information, and then sends the processed information through the antenna 111.

The method performed by the network side device in the foregoing embodiments may be implemented in the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor, and is connected to the memory 115 through a bus interface to invoke a program in the memory 115, to perform an operation of a network device shown in the foregoing method embodiments.

The network side device may further include a network interface 116, where the interface is, for example, a common public radio interface (common public radio interface, CPRI).

Specifically, the network side device 1100 in this embodiment of the present invention further includes: instructions or a program stored in the memory 115 and executable on the processor 114. The processor 114 invokes the instructions or the program in the memory 115 to perform the method performed by each module shown in FIG. 8, and achieves the same technical effects. To avoid repetition, details are not described herein again.

An embodiment of this application further provides a readable storage medium. The readable storage medium stores a program or instructions. When the program or the instructions are executed by a processor, the foregoing processes in embodiments of the model selection method are implemented, and the same technical effects can be achieved. To avoid repetition, details are not described herein again.

The processor is the processor in the terminal described in the foregoing embodiments. The readable storage medium may be non-volatile or non-transient. The readable storage medium includes a computer-readable storage medium, for example, a computer read-only memory ROM, a random access memory RAM, a magnetic disk, an optical disc, or the like.

An embodiment of this application further provides a chip. The chip includes a processor and a communication interface. The communication interface is coupled to the processor. The processor is configured to execute a program or instructions to implement the foregoing processes in embodiments of the model selection method, and can achieve the same technical effects. To avoid repetition, details are not described herein again.

It should be understood that, the chip described in this embodiment of this application may also be referred to as a system-level chip, a system chip, a chip system, a system on chip, or the like.

An embodiment of this application further provides a computer program/program product. The computer program/program product is stored in a storage medium. The computer program/program product, when executed by at least one processor, implements the foregoing processes in embodiments of the model selection method, and can achieve the same technical effects. To avoid repetition, details are not described herein again.

An embodiment of this application further provides a model selection system, including a terminal and a network side device. The terminal may be configured to perform the foregoing steps of the model selection method, and the network side device may be configured to perform the foregoing steps of the model selection method.

It should be noted that in this specification, the term “include”, “comprise”, or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. Without more limitations, an element defined by a sentence “including one” does not exclude existence of other same elements in a process, a method, an object, or an apparatus that includes the element. In addition, it should be noted that the scope of the method and apparatus in implementations of this application is not limited to the shown or discussed orders in which the functions are implemented. Alternatively, depending on the functions, the functions maybe performed in a substantially simultaneous manner or in a reverse order. For example, the described method may be performed in an order different from the described order, and various steps may be added, omitted, or combined. In addition, features described with reference to some examples may be combined in other examples.

Through the descriptions of the foregoing implementations, a person skilled in the art may clearly understand that the methods in the foregoing embodiments may be implemented via software and a necessary general hardware platform, and certainly, may also be implemented by hardware, but in many cases, the former manner is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc) and includes several instructions for instructing a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. A model selection method, comprising:
sending, by a terminal, first computing information, wherein the first computing information is related to a computing capability of the terminal, and the first computing information is used for determining a first AI model used by the terminal; and
receiving, by the terminal, parameter(s) of the first AI model, wherein the first AI model is used by the terminal to perform a target task.

2. The method according to claim 1, wherein the first AI model is obtained by splitting a second AI model based on the first computing information and/or second computing information of a network side device.

3. The method according to claim 1, wherein the first computing information is related to at least one of the following of the terminal: a memory size, a capability of a central processing unit, a hard disk data size, computing, or a load size.

4. The method according to claim 3, wherein after the receiving, by the terminal, parameter(s) of the first AI model, the method further comprises:
obtaining, by the terminal, first data, wherein the first data is related to the target task; and
processing, by the terminal, the first data based on the first AI model.

5. The method according to claim 3, wherein after the receiving, by the terminal, parameter(s) of the first AI model, the method further comprises:
receiving, by the terminal, second data, wherein the second data is related to the target task, the second data is a result obtained through processing based on a third AI model, and the third AI model is obtained by splitting the second AI model based on the first computing information and/or the second computing information of the network side device; and
processing, by the terminal, the second data based on the first AI model.

6. The method according to claim 3, wherein after the receiving, by the terminal, parameter(s) of the first AI model, the method further comprises:
obtaining, by the terminal, third data, wherein the third data is related to the target task;
processing, by the terminal, the third data based on the first AI model, to obtain fourth data;
sending, by the terminal, the fourth data; and
receiving, by the terminal, fifth data, wherein the fifth data is a result obtained through processing based on a third AI model, and the third AI model is obtained by splitting the second AI model based on the first computing information and/or the second computing information of the network side device.

7. A model selection method, comprising:
determining, by a network side device based on first computing information of a terminal, a first AI model used by the terminal, wherein the first computing information is related to a computing capability of the terminal; and
sending, by the network side device, parameter(s) of the first AI model, wherein the first AI model is used by the terminal to perform a target task.

8. The method according to claim 7, wherein the method further comprises at least one of the following:
obtaining, by the network side device, the first computing information; or
obtaining, by the network side device, second computing information of the network side device.

9. The method according to claim 7, wherein the determining, by a network side device based on first computing information of a terminal, a first AI model used by the terminal comprises:
splitting, by the network side device, a second AI model based on the first computing information of the terminal and the second computing information of the network side device, to obtain the first AI model used by the terminal and a third AI model used by the network side device.

10. The method according to claim 9, wherein
the first computing information is related to at least one of the following of the terminal: a memory size, a capability of a central processing unit, a hard disk data size, computing, or a load size; and
the second computing information is related to at least one of the following of the network side device: a memory size, a capability of a central processing unit, a hard disk data size, computing, or a load size.

11. The method according to claim 9, wherein after the sending, by the network side device, parameter(s) of the first AI model, the method further comprises:
sending, by the network side device, second data, wherein the second data is related to the target task, and the second data is a result obtained through processing based on the third AI model.

12. The method according to claim 9, wherein after the sending, by the network side device, parameter(s) of the first AI model, the method further comprises:
receiving, by the network side device, fourth data, wherein the fourth data is obtained by the terminal by processing third data based on the first AI model;
processing, by the network side device, the fourth data based on the third AI model, to obtain fifth data; and
sending, by the network side device, the fifth data.

13. A terminal, comprising a processor and a memory, wherein the memory stores a program or instructions executable on the processor, and the program or the instructions, when executed by the processor, implement a model selection method, wherein the model selection method comprises:
sending first computing information, wherein the first computing information is related to a computing capability of the terminal, and the first computing information is used for determining a first AI model used by the terminal; and
receiving parameter(s) of the first AI model, wherein the first AI model is used by the terminal to perform a target task.

14. A network side device, comprising a processor and a memory, wherein the memory stores a program or instructions executable on the processor, and the program or the instructions, when executed by the processor, implement the steps of the model selection method according to claim 7.

15. A non-transitory readable storage medium, wherein the readable storage medium stores a program or instructions, and the program or the instructions, when executed by a processor, implement the steps of the model selection method according to claim 1.

16. A non-transitory readable storage medium, wherein the readable storage medium stores a program or instructions, and the program or the instructions, when executed by a processor, implement the steps of the model selection method according to claim 7.

17. A computer program product, wherein the program product is executed by at least one processor to implement the model selection method according to claim 1.

18. A computer program product, wherein the program product is executed by at least one processor to implement the model selection method according to claim 7.

19. A chip, wherein the chip comprises a processor and a communication interface, the communication interface is coupled to the processor, and the processor is configured to execute a program or instructions, to implement the model selection method according to claim 1.

20. A chip, wherein the chip comprises a processor and a communication interface, the communication interface is coupled to the processor, and the processor is configured to execute a program or instructions, to implement the model selection method according to claim 7.
